(19) United States
(12) Patent Application Publication
(10) Pub. No.: US 2009/0296099 A1
(43) Pub. Date: Dec. 3, 2009

(54) Interferometric Layer Thickness Determination

(76) Inventors: Kurt Burger, Friolzheim (DE); Thomas Beck, Kirchberg (DE); Hartmut Spennemann, Aschaffenburg (DE); Stefan Grosse, Gerlingen (DE); Bernd Schmidtke, Gerlingen (DE); Ulrich Kallmann, Tuebingen (DE); Sebastian Jackisch, Ludwigsburg (DE)

Correspondence Address: KENYON & KENYON LLP, ONE BROADWAY, NEW YORK, NY, 10004, US

(21) Appl. No.: 11/992,402

(22) PCT Filed: Aug. 2, 2006
(86) PCT No.: PCT/EP2006/064954

§ 371 Date: Jul. 17, 2009

(30) Foreign Application Priority Data
Sep. 22, 2005 (DE) 10 2005 045 512.3
Apr. 6, 2006 (DE) 10 2006 016 132.7

(51) Int. Cl. G01B 11/02

(52) U.S. Cl. 356/503

(57) ABSTRACT

An interferometric measuring device for measuring layer thicknesses of partially transparent layers on substrates, especially of wear protection layers based on carbon, having a scanning device which scans these layers automatically in its depth direction, using which an interference plane is displaceable relative to the layer structure, having an interferometer part that has a white light interferometer and/or a wavelength-scanning interferometer. Also described is a corresponding evaluation method.

### FIELD OF THE INVENTION

The present invention relates to an interferometric measuring device for measuring thicknesses of partially transparent layers on substrates, having a scanning apparatus, which scans them automatically in its depth direction, using which an interference plane is displaceable relative to the layer structure, and having a white light interferometer and/or an interferometer part, having a wavelength scanning interferometer, to which an input radiation is supplied, for the measurement, by an irradiation unit, which is split using a beam splitter and supplied, in one part, to a reference arm via a reference ray path as a reference beam, and in the other part, is supplied via an object beam path as object beam to an object arm which has the layer structure during the measurement, and having an image recorder which records the interfering radiation returning from the reference arm and the object arm and converts it into electrical signals, as well as having a downstream evaluation device for making available the measuring results.

### BACKGROUND INFORMATION

The present invention also relates to a method for the interferometric measuring of the thickness of partially transparent layers on substrates, in which an interference plane which is determined by the optical path length of an object beam guided in an object beam path and by the optical path length of a reference beam guided in a reference beam path, is displaced for the depth scanning of the layer structure in the depth direction relative to the position of the layer, generates an interference pattern using methods of white light interferometry or a wavelength scanning interferometry, and the interference pattern is recorded using an image recorder, and is automatically evaluated using an evaluation device, in order to show the measuring results with regard to the boundary areas of the layer structure.

Such an interferometric measuring device is discussed in German DE 101 31 779 A1. In this interferometric measuring device, which operates according to the measuring principle of so-called white light interferometry, a surface structure of a measuring object is scanned in the depth direction (z direction), using a scanning apparatus, in that the length of a reference light path is changed relative to the length of an object light path, so that the interference plane, which is defined by the cooperation of a reference beam guided through a reference arm and an object beam guided through an object arm, is displaced relative to the object surface. One specialty of this known interferometric measuring device is that several surface areas of the measuring object are able to be recorded and scanned at the same time, for which a special optical system, namely, a so-called superposition optical system or an optical system having a sufficiently great depth of focus, or a multifocal optical system, is situated in the object arm, using which the various surface areas are able to be recorded at the same time.

As a result, correspondingly different beam paths come about in the object arm for the various surface areas to be measured, so that the surface areas are then measured while making relative changes in the optical length of the object light path to the optical length of the reference light path, for instance, by varying a reference mirror in the depth scanning direction, with respect to its topographical surface structure. This design is especially suitable for scanning of laterally adjacent surface areas, which may have different orientations or may be offset in the depth direction. A parallelism or a thickness of the various surfaces are also able to be measured. In this context, the surfaces that are spatially separated from one another are constantly recorded at the same time, so that an adjustment of the optics in the object arm has to be provided that takes into consideration the relative positional relationship of the two surfaces that are to be measured. In the above-named document, no partially transparent layers on a substrate are described.

In an interferometric measuring device shown in DE 197 21 843 C1, various surface areas of an object, particularly even in tight bores, are also able to be measured using a partly common object arm, object beam paths associated with the various surface areas being likewise formed. In this instance, the measured surface areas are separated from one another, so that, for example, the roundness of a cylinder bore may be checked. The various surface areas are distinguished based on different polarization directions of the associated object beams. In this case, too, the imaging of the various surface areas takes place simultaneously via the object arm.

One additional interferometric measuring device shown in WO 01/38820 A1, which is also based on white light interferometry, is constructed so that, using it, thickness measurement, distance measurement and/or profile measurement, may also be undertaken on layers lying one behind another, for instance, in opthalmological measurement, the thickness of the cornea, the depth of the anterior chamber, the thickness of the retina layer or the retina surface profile. Various light paths are also developed for this in the object arm, which are assigned to various layers and boundary areas, in order to achieve as rapid as possible a measurement. The object beams (measuring beams) have different optical properties for distinguishing and assigning the various measured surfaces and boundary areas, such as a different polarization direction or a different wavelength; a change in the detour of the various object light paths in the object arm is also possible, but it leads to a loss in sensitivity, which is referred to in this document.

More basic discussions on white light interferometry are shown in T. Dresel, G. Hausler, H. Venzke, “Three-dimensional sensing of rough surfaces by coherence radar”, Applied Optics Vol. 31, 919 (1992) as well as in P. de Groot and L. Deck, Journal of Modern Optics, “Surface profiling by analysis of white light interferograms in the spatial frequency domain”, Journal of Modern Optics, Vol. 42, 389-501 (1995). In Kieran G. Larkin, “Efficient nonlinear algorithm for envelope detection in white light interferometry”, J. Opt. Soc. Am. A, (4):832-843, 1996 it is stated how, using a special algorithm, the modulation M of a correlation curve (correlogram) is able to be determined from recorded intensity values, according to the so-called FSA method (five-sample adaptive method). Another procedure for identifying and evaluating a correlation curve is by observing the interference contrast.

At this time it is not possible to measure nondestructively and at sufficient speed, as well as accuracy, the layer thickness of the wear protection layers based on carbon, so-called C layers. In methods currently used, the C layer is start-ground, and consequently destroyed (calotte grinding method). Commercially available white light interferometers (WLI) are highly accurate, rapidly measuring interferometric measuring systems which, however, are only able to measure topographic surfaces (“2½ D measurement”).

A C layer that is applied to a surface is not able to be measured, using today's systems, with regard to the thickness of its layer.

### SUMMARY OF THE INVENTION

It is an object of the exemplary embodiments and/or exemplary methods of the present invention to provide an interferometric measuring device and a method for measuring layer thicknesses, particularly those of C layers.

This object is attained using the method having the features of described herein and using the method having the features of described herein.

In the device, it is provided that the scanning device is developed in such a way that, at a constant reference beam path and object beam path, the associated scanning path is developed to be at least as great as the distance that is to be expected, or has been ascertained in a pre-measurement, between at least two successively situated, one behind the other, boundary areas of the layer structure that are to be recorded, possibly with the addition of a depth structure of the boundary surfaces that are to be expected, and that, in the development of interferometer part IT, having irradiation unit LQ as white light interferometer WLT, the coherence length LC of the input radiation is selected to be at most so great that the interference maxima of the correlation curves occurring, one after another, in response to the depth scanning are distinguishable at the boundary surfaces that are to be recorded, and/or that in response to the development of interferometer part IT having the irradiation unit is developed as wavelength-scanning interferometer WLSI, the irradiation unit LQ is developed to have a narrow-band, tunable input radiation, the bandwidth of the input radiation being selected to be of a magnitude so that the smallest distance apart of the boundary areas that lie one behind the other and are to be recorded, that is to be expected or is estimated by pre-measurement, is resolvable, and/or, in response to the development of interferometer part IT as a wavelength-scanning interferometer WLSI having a spectral broadband irradiation unit and a wavelength-scanning optical spectrum analyzer as detector, the bandwidth of the input radiation is selected to be of a magnitude so that the smallest distance apart of the boundary surfaces that lie one behind the other and are to be recorded, that is to be expected or is estimated by pre-measurement, is resolvable, and the wavelength spectrum of irradiation unit LQ that is used is adjusted with respect to the spectral transparency of the layer that is to be measured, in such a way that the latter is at least partially penetrable by radiation.

The object relating to the method is attained in that, during the depth scanning of the layer that is to be measured and of the boundary areas bordering them, object beam OST is guided in a scanning cycle over the same object beam path, and reference beam RST is guided over the same reference beam path, and that, in using the method of white light interferometry, coherence length LC of the input radiation of an irradiation unit LQ, that is coupled into the interferometer, is selected to be at most of such magnitude that the interference maxima of correlation curve KG occurring one after another in response to the depth scanning at the boundary surfaces, that are to be recorded, are distinguished, and in using the method of wavelength-scanning interferometry, the bandwidth of the input radiation is selected to be of a magnitude of the distance apart of the boundary surfaces that are to be recorded, that is to be expected or is estimated by pre-measurement, are resolved, a wavelength spectrum of irradiation unit LQ being selected in which the layer to be measured is able to be at least partially penetrated by radiation.

By using these measures, boundary areas of the layer structure including the outer boundary area (surface) are able to be detected reliably, and analyzed accurately, if desired. In this context, the transitions (boundary areas or boundary layers), for example, may also be recorded in smaller regions of the layer structure while running through the scanning path, and measured more accurately if desired, since the correlation curves are uniquely determined. The layer thicknesses may then the determined by evaluation of the transitions.

If the layers that are to be measured are carbon-based wear protection layers (C layers), and if the wavelength spectrum of irradiation unit LQ lies in the near-infrared spectral range (NIR), the device described and the method employed will enable one to make a nondestructive measurement that is performed both point-wise and area-wise. With that, the upper side and the lower side of such C layers may be measured tomographically and the thickness of the layer may be ascertained thereby, which makes possible a downstream process control and/or quality control on relevant production parts.

It is particularly advantageous if the wavelength spectrum of irradiation unit LQ is in the range of 1100 nm through 1800 nm. Then, based on their optical properties, the C layers are partially transparent, whereby both at the upper side (boundary layer air/C layer) and at the lower side of the layer (boundary layer C layer/substrate) a correlation curve is able to be created, which is able to be detected.

One embodiment variant has a laser-pumped photonic crystal fiber PCF as irradiation unit LQ, in this instance. Such light sources are distinguishable by their very broad optical spectrum (Δλ>500 nm).

Greater lateral areas of the boundary areas may be measured relatively rapidly, and also with respect to one another, in that image recorder BA has a planar resolution in the x/y direction that is higher than the image of the local height changes of the layer surface in the x/y direction. Using these measures, one may also detect and evaluate relative changes of the course of the layers with respect to one another.

If image recorder BA is an InGaAs CCD camera, a high sensitivity in the corresponding spectral range may be achieved, especially in connection with a PCF light source, so that the plotted correlation curves have very small half widths of <4 μm.

In a further specific embodiment, reference arm RA has a displaceable reference mirror RS developed as reference surface RF. This makes it possible to perform a depth scan without movable parts in object OA.

If reference surface RF is displaceable using a piezoelectric actuating unit VE, great accuracy may be achieved thereby. In addition, such systems stand out by their great robustness.

One embodiment variant provides a lens system LS2, LS3 in reference arm RA and/or in object arm OA, which are developed as NIR microscope objectives. This makes it possible to implement particularly compact measuring devices which are also optimally adapted to the measuring task, which is to measure the layer thickness of C layers.

One advantageous embodiment for recording and evaluating is that in evaluation device AW, algorithms are programmed, using which, the boundary areas of the layer are able to be recorded separately from one another by having an allocation take place by the sequence of correlation curves KG occurring at the boundary areas, during a depth scanning cycle.

One method variant provides that the intensity patterns of correlation curves KG are recorded pixel-wise by image recorder BA during depth scanning, and are stored in a postconnected evaluation device AW. Layer thickness data may thereby be obtained area-wise.

If it is provided that the intensity patterns of correlation curves KG are allocated to separate memory areas in evaluation device AW, and, during the depth scanning, the correlation curves in connection with the boundary areas are evaluated based on maximum modulation M of the intensities yielded by the interference patterns and are allocated to the memory areas, the respective correlation curves being brought into relationship with their depth-scanning position, then a high efficiency comes about in the evaluation and provision of the measuring results, at a relatively slight effort.

In evaluation device AW, during depth scanning, if for each image point separately two successive correlation curves KG are detected, and the optical layer thickness of the layer is determined from the position of the correlation curves, one may very efficiently use this to calculate planar representations of the layer thickness and appropriately display them graphically, which is of particular advantage with respect to a layer inspection in quality assurance.

A particularly simple evaluation provides, in this instance, that the position of the correlation curves is determined using a center of gravity determination of an envelope of correlation curves KG. Using this method, the position of the boundary layers may be determined especially accurately in depth direction Z.

In the determination of the position of two partially overlapping correlation curves KG, one method variant provides that a mutual influencing of the signals is taken into consideration in response to the separation of the intensity signals. Based on the small half width of correlation curves KG, this makes it possible to measure even very slight layer thicknesses having d<1.5 μm.

One method step further provides that, using a previously determined refractive index of the layer, an actual layer thickness of the layer is calculated from the optical layer thickness for each image point, which is advantageous with regard to an inspection of the layers mentioned at the outset. The measuring results are consequently the actual layer thickness in each pixel as well as a tomographic image of the C layer.

The refractive index of the layer may be previously determined very simply, in this instance, using a partially coated reference sample.

The exemplary embodiments and/or exemplary methods of the present invention is explained in more detail below with reference to an exemplifying embodiment depicted in the FIGURE.

### BRIEF DESCRIPTION OF THE DRAWINGS

FIG. 1 shows an interferometric measuring device for measuring layer thicknesses, in a schematic representation.

FIG. 2 shows a schematic representation of a white light interferometer WLI for measuring layer thicknesses.

FIG. 3 shows a typical intensity of a pixel of an InGaAs CCD camera over a scanning path having two particularly overlapping correlation curves during the measurement of a C layer.

### DETAILED DESCRIPTION

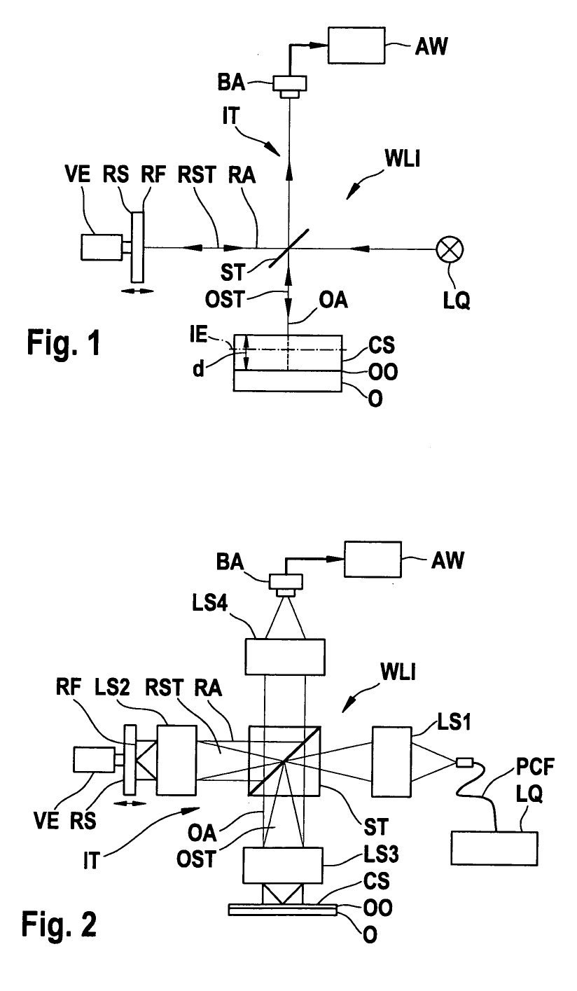

FIG. 1 schematically shows an interferometric measuring device developed for measuring layers, particularly wear protection layers based on carbon, so-called C layers, on an object O, which is developed at least partially transparent for an object beam OST.

An interferometer part IT developed as a white light interferometer WLI has a beam splitter ST, by which, using an irradiation unit LQ, an input radiation is split up into an object beam OST that is guided through an object arm OA and into a reference beam RST that is guided through a reference arm RA, in order to generate an interference pattern that may be evaluated, as is known per se and as is described in greater detail, for instance, in the documents named at the outset, by superimposing reference beam RST, that is returned at a reference surface RF, and object beam OST that is returned by the scanned layer structure of object O. With respect to object arm OA, an interference plane IE is situated in the area of measuring object O or rather, of C layer CS. During the depth scanning of the layer structure in depth direction Z, interference plane IE is displaced relative to C layer CS in the depth direction, whereby different interference patterns occur over the trace of the depth scanning. The depth scanning of C layer CS of interference plane IE may take place in various ways, namely, by changing the optical path length of the reference beam, particularly by moving reference surface RF developed as reference mirror RS, by moving measuring object O in depth direction Z or by moving the objective in the depth direction or by moving the entire sensor relative to measuring object O.

In the exemplary embodiment shown in FIG. 1, an adjustment of reference mirror RF in reference arm RA is made, using an adjusting unit VE, for instance, a piezoelectric adjusting unit VE, in discrete steps in the depth direction Z. To measure C layer CS, the interference pattern is recorded using an image recorder BA and converted to corresponding electrical signals, and is evaluated in a connecting evaluation device AW, so as to obtain the measuring results that give information on the layer thickness of the C layer.

As the image recorder, a camera may be provided which has side-by-side image recording elements pixel-wise in the x-y direction, and which resolves the imaged interference pattern area-wise, so that during depth scanning, a plurality of traces of the layer structure assigned to the individual image elements are able to be recorded at the same time and evaluated.

The measurement of the boundary areas of C layer CS may advantageously be carried out according to the principle of white light interferometry. For this, an irradiation unit or a light source LQ is used, which emits a short coherent radiation, for example, one or more superluminescence diodes SLD1 . . . SLD4 that are coupled together. In this connection, interference occurs only if the optical wavelength difference between reference beam RST and object beam OST is within coherence length LC of the radiation emitted by irradiation unit LQ. The interference signal created is also designated as correlogram KG in white light interferometry.

Object beam OST, according to the exemplary embodiments and/or exemplary methods of the present invention, penetrates at least partially into C layer CS, in this instance, and is reflected both at the upper boundary area (e.g. air/C layer CS) and at the lower boundary area (C layer CS/object surface OO of object O), and generates with superimposed reference beam RST, at image recorder BA, one upper side signal OSS and one lower side signal USS for each image point, which are detected separately or partially overlapping, and are evaluated, and the layer thickness d is able to be determined from this, while taking into consideration the refractive index.

FIG. 2 shows a schematic representation of a white light interferometer WLI for the area-wise measurement of the layer thicknesses of C layers. The basic design corresponds to the interferometric measuring device shown in FIG. 1.

Irradiation unit or light source LQ is developed appropriately to the measuring task, as a light source having a near-infrared spectral range (NIR). As light sources LQ in the near-infrared spectral range, so-called ASE (amplified spontaneous emission) light sources (e.g. laser-pumped Er fibers), laser-pumped photonic crystal fibers (PCF) or superluminescence diodes SLD are used. ASE light sources and superluminescence diodes are coupled into white light interferometer WLI via an optical free beam or by a light-conducting fiber. Laser-pumped photonic crystal fibers are directly connected to interferometer part IT of white light interferometer WLI.

In the development of the interferometric measuring device as a white light interferometer WLI, one should take care that the optical spectrum of its broadband light source LQ is selected in such a way that the layer structures to be investigated are partially transparent at least as far down as one lower nontransparent carrier substrate. Accordingly, image recorder BA or detector is adjusted to the irradiation unit or light source LQ so that one may obtain as high a sensitivity as possible in the spectral range used. Therefore, in the case of area-wise measuring white light interferometers, an InGaAs CCD camera is used as image recorder BA in the near-infrared spectral range (ca. 1000 nm through 1800 nm). This also makes it possible for image recorder BA to have a planar resolution in the x/y direction that is greater than the imaging of the local height changes of the layer surface in the x/y direction.

In the example shown, the depth scan is carried out using reference mirror RS mounted on a piezocrystal in reference arm RA, which is used as reference surface RF. The piezocrystal represents adjusting unit VE, which may be activated, for example, using a computer, and is therefore able to bring the reference mirror very accurately into position. Object arm OA thus has no moving parts.

Reference arm RA and object arm OA have lens systems LS2, LS3 which are designed as NIR microscope objectives, in the example shown. Lens systems LS1 and LS4 are used for coupling in the input radiation and for focusing object beam OST with superimposed reference beam RST onto image recorder BA, respectively.

In evaluation device AW that is postconnected to image recorder BA, algorithms are programmed, using which, the boundary areas of the layer are able to be recorded separately from one another by having an allocation take place by the sequence of correlation curves KG occurring at the boundary areas, during a depth scanning cycle. The intensity patterns of correlation curves KG are recorded pixel-wise during the depth scanning, in this instance, using image recorder BA, and are stored in a postconnected evaluation device AW.

The method according to the present invention provides, in this context, that in the depth scanning of the layer that is to be measured, and the boundary areas that border on it, in one scanning cycle, object beam OST is guided over the same object beam path and reference beam RST is guided over the same reference beam path. In the application of the method of white light interferometry, coherence length LC of input radiation of an irradiation unit LQ that is coupled into the interferometer is selected to be at most so great that the interference maxima of the correlation curves that occur one after another during the depth scanning at the boundary areas, that are to be recorded, are distinguished. In the application of the method of wavelength-scanning interferometry, the bandwidth of the input radiation is selected to be so great that the smallest distance apart of the boundary areas that are to be recorded, that is to be expected or estimated by pre-measurement, is resolved. In this context, a wavelength spectrum of irradiation unit LQ is selected in which the layer to be measured is at least partially able to be penetrated by radiation.

For the exact recording and allocation of correlation curves KG to the respective boundary areas, an evaluation based on interference contrasts may be made. However, for a better recording, modulation M may be ascertained, as it is shown together with the associated intensity pattern over the scanning path in depth direction Z. In order to ascertain modulation M, in evaluation device AW a special algorithm is taken as a basis, namely the so-called FSA (five sample adaptive) algorithm, which is in turn based on the scanning of five successive intensity values of the interferogram, and from which the phase of the respective scanning position in the scanning path may also be determined. With reference to the details of the FSA algorithm, we refer to the document of Larkin named at the outset.

One specialty of the present interferometric measuring device and the measurement method is that the scanning path in depth direction Z is selected to be at least so great that the entire range is scanned in which the boundary layers that are to be recorded are present, the correlation curves occurring at the various boundary areas during the scanning being recorded, in order to determine from this the presence of the boundary areas, using evaluation device AW. In this context, besides the coarse recording of the boundary areas, one may also undertake a fine recording of the height structures of the individual boundary areas. The area-wise recording, via the image-recording elements of image recorder BA or the camera, simultaneously permits the recording of the height measuring data over several laterally adjacent traces (in depth direction Z), in this instance, so that 3D height data of the respective boundary areas may be acquired.

It may be provided, in this context, that the intensity patterns of correlation curves KG in evaluation device AW are allocated to separate memory areas SB1, SB2, . . . and that, during the depth scanning, the correlation curves in connection with the boundary areas are ascertained based on the maximum modulation M of the intensities coming about from the interference patterns, and are allocated to memory areas SB1, SB2, . . . , the respective correlation curves being put into relation with their depth scanning position.

During the depth scanning, separately two successive correlation curves KG are detected in evaluation device AW for each image point, and the optical layer thickness of the layer is determined from the position of the correlation curves. The exact position of the correlation curves may, on the one hand, be determined using a center of gravity determination of an envelope of correlation curves KG. In the case of two partially overlapping correlation curves KG, in the case of the separation of the intensity signals, a mutual influencing of the signals may be taken into consideration for the determination of the position.

The optical layer thickness may be calculated for each image point, using subtraction of the position of the correlation curves with reference to the scanning in the depth direction Z. Using a previously determined refractive index of the layer, an actual layer thickness of the layer may be calculated for each image point, in a further calculating step, from the optical layer thickness. The refractive index of the layer may, for instance, have been previously determined, using a partially coated reference sample, and may already be stored in evaluation device AW.

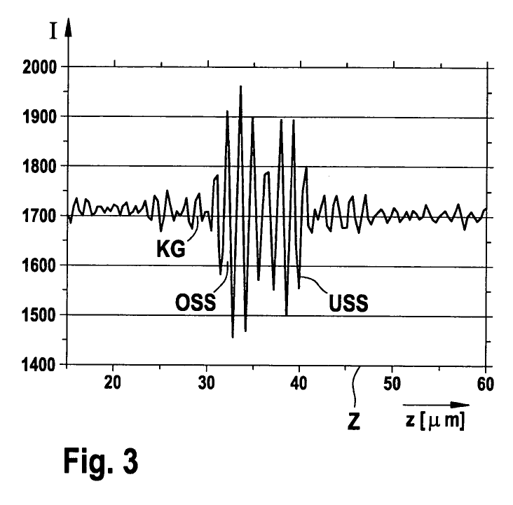

FIG. 3 shows an exemplary measurement of the intensity pattern of a pixel of an InGaAs CCD camera during the measurement of a C layer.

The intensity is shown as a function of the scanning path in the depth direction Z. The figure shows two correlation curves KG which partially overlap, in the example shown. Upper side signal OSS and lower side signal USS result from upper boundary area (air/C layer CS) and at lower boundary area (C layer CS/object surface OO), from which layer thickness d of the C layer may be determined for this image point, from the position and taking into consideration the refractive index.

The superstructures of the interferometric measuring device described above, and the method carried out using them make possible a non-destructive, point-wise as well as area-wise measuring, in particular, of boundary areas in layers that are optically partially transparent to radiation, especially of wear protection layers based on carbon. With that, the upper side and the lower side of such C layers may be measured tomographically and the layer thickness of the C layer may be ascertained nondestructively thereby, which makes possible a downstream process control and/or quality control on relevant production parts, such as common-rail injector nozzle-needle tips.

1-19. (canceled)

20. An interferometric measuring device for measuring layer thicknesses of partially transparent layers on substrates, comprising:
a scanning device to scan the layers automatically in its depth direction, using which an interference plane is displaceable relative to the layer structure, including:
an interferometer part that has at least one of a white light interferometer and a wavelength-scanning interferometer, to which an input radiation is supplied, for the measurement, by an irradiation unit, which is split up using a beam splitter, and is supplied, in one part, to a reference arm via a reference beam path as the reference beam and, in an other part, is supplied to an object arm having the layer structure during the measurement, via an object beam path as the object beam,
an image recorder to record interfering radiation returning from the reference arm and the object arm, and converts it into electrical signals, and
a postconnected evaluation device to provide the measuring results,
wherein the scanning device is developed so that, at a constant reference beam path and object beam path, an associated scanning path is developed to be at least as great as the distance, that is to be expected or has been ascertained in a pre-measurement, between at least two boundary areas of the layer structure that are to be recorded, situated one behind another, if necessary with the addition of a depth structure of the boundary areas that is to be expected, and
wherein at least one of the following is satisfied:
a) for the interferometer part having the irradiation unit as a white light interferometer, a coherence length of the input radiation is selected to be at most so great that an interference maxima of the correlation curves occurring one after another during the depth scanning are distinguishable at the boundary areas that are to be recorded,
b) for the interferometer part having the irradiation unit as a wavelength-scanning interferometer (WLSI), the irradiation unit has a narrowband, tunable input radiation, the bandwidth of the input radiation being selected to be so large that the smallest distance apart, of the boundary areas lying one behind another that are to be recorded, to be expected or to be estimated by the pre-measurement, is resolvable,
c) for the interferometer part as a wavelength-scanning interferometer having a spectrally broadband irradiation unit and a wavelength-scanning optical spectrum analyzer as detector, the bandwidth of the input radiation is selected to be so large that the smallest distance apart of the boundary areas lying one behind another that are to be recorded, that is to be expected or that is to be estimated by pre-measurement, is resolvable, and
d) a wavelength spectrum of the irradiation unit used is adjusted with respect to the spectral transparency of the layer that is to be measured, so that the layer is at least partially able to be transparent to radiation.

21. The measuring device of claim 20, wherein the layers to be measured are wear protection layers based on carbon, and the wavelength spectrum of the irradiation unit is in the near-infrared spectral range.

22. The measuring device of claim 20, wherein the wavelength spectrum of the irradiation unit is in the range of 1100 nm through 1800 nm.

23. The measuring device of claim 20, wherein the irradiation unit has a laser-pumped photonic crystal fiber.

24. The measuring device of claim 20, wherein the image recorder has a planar resolution in the x/y direction that is greater than the imaging of the local height changes of the layer surface in the x/y direction.

25. The measuring device of claim 20, wherein the image recorder is an InGaAs CCD camera.

26. The measuring device of claim 20, wherein the reference arm has a displaceable reference mirror developed as a reference surface.

27. The measuring device of claim 26, wherein the reference surface (RF) is displaceable using a piezoelectric adjustment unit (VE).

28. The measuring device of claim 20, wherein at least one of the reference arm and the object arm have lens systems that are developed as NIR microscope objectives.

20. The measuring device of claim 20, wherein algorithms are programmed in the evaluation device, using which, the boundary areas of the layer are able to be recorded separately from one another by having an allocation take place by the sequence of the correlation curves occurring at the boundary areas, during a depth scanning cycle.

30. A method for an interferometric measuring of layer thicknesses of partially transparent layers on substrates, the method comprising:
displacing an interference plane, which is determined by an optical path length of an object beam guided in an object beam path and by an optical path length of a reference beam guided in a reference beam path, for a depth scanning of the layer structure in a depth direction relative to a position of the layer;
generating an interference pattern using methods of white light interferometry or a wavelength-scanning interferometry; and
recording the interference pattern using an image recorder, and automatically evaluating using an evaluation device, to show the measuring results with regard to the boundary areas of the layer structure;
wherein, in the depth scanning of the layer that is to be measured, and of the boundary areas that border on it, the object beam is guided in one scanning cycle over a same object beam path and the reference beam is guided over the same reference beam path, and in the application of the method of white light interferometry, the coherence length of the input radiation of an irradiation unit that is coupled into the interferometer is selected to be at most so great that the interference maxima of the correlation curves that occur one after another, at the boundary areas that are to be recorded, during the depth scanning, are distinguished and in the application of the method of wavelength-scanning interferometry, the bandwidth of the input radiation is selected to be so large that the smallest distance apart of the boundary areas to be recorded, that is to be expected or estimated by pre-measurement, is resolved, a wavelength spectrum of the irradiation unit being selected in which the layer to be measured is at least partially able to be penetrated by radiation.

31. The method of claim 30, wherein wear protection layers based on carbon are mounted in the object arm for the measurement, and the near-infrared spectral range is used as the input radiation.

32. The method of claim 30, wherein the intensity patterns of the correlation curves are recorded pixel-wise during the depth scanning, using the image recorder, and are stored in a postconnected evaluation device.

33. The method of claim 32, wherein the intensity patterns of the correlation curves are allocated to separate memory areas in the evaluation device, and during the depth scanning, the correlation curves in connection with the boundary areas are ascertained based on the maximum modulation of the intensities coming about from the interference patterns, and are allocated to the memory areas, the respective correlation curves being put into relation with their depth scanning position.

34. The method of claim 30, wherein, during the depth scanning, for each image point separately two successive correlation curves are detected in evaluation device, and the optical layer thickness of the layer is determined from the position of the correlation curves.

35. The method of claim 34, wherein the position of the correlation curves is determined using a center of gravity determination of an envelope of the correlation curves.

36. The method of claim 30, wherein, in the determination of the position of two partially overlapping correlation curves, a mutual influencing of the signals is taken into consideration in the separation of the intensity signals.

37. The method of claim 30, wherein an actual layer thickness of the layer is calculated for each image point from the optical layer thickness, using a previously determined refractive index of the layer.

38. The method of claim 37, wherein the refractive index of the layer is determined using a partially coated reference sample.
